(19) United States
(12) Patent Application Publication
(10) Pub. No.: US 2009/0321405 A1
(43) Pub. Date: Dec. 31, 2009

(54) Ni-Co-Cr High Strength and Corrosion Resistant Welding Product and Method of Preparation

(75) Inventors: Brian A. Baker, Kitts Hill, OH (US); Gaylord D. Smith, Huntington, WV (US); Ronald D. Gollihue, Grayson, KY (US)

Correspondence Address: THE WEBB LAW FIRM, P.C., 700 KOPPERS BUILDING, 436 SEVENTH AVENUE, PITTSBURGH, PA, 15219, US

(73) Assignee: HUNTINGTON ALLOYS CORPORATION, Huntington, WV (US)

(21) Appl. No.: 12/488,786

(22) Filed: Jun. 22, 2009

Related U.S. Application Data
(60) Provisional application No. 61/075,980, filed on Jun. 26, 2008.

(51) Int. Cl. B23K 35/34; C22F 1/10; C22C 19/05; C22C 30/00; C22F 1/00

(52) U.S. Cl. 219/146.23; 148/677; 148/707; 420/447; 420/443; 420/448; 420/588; 420/586

(57) ABSTRACT

A nickel (Ni), chromium (Cr), cobalt (Co), iron (Fe), molybdenum (Mo), manganese (Mn), aluminum (Al), titanium (Ti), niobium (Nb), silicon (Si) welding alloy, articles made therefrom for use in producing weldments and methods for producing these weldments. The welding alloy contains in % by weight about: 23.5 to 25.5% Cr, 15 to 22% Co, up to 3% Fe, up to 1% Mo, up to 1% Mn, 1.1 to 2.0% Al, 0.8 to 1.8% Ti, 0.8 to 2.2% Nb, 0.05 to 0.28% Si, up to 0.3% Ta, up to 0.3% W, 0.005 to 0.08% C, 0.001 to 0.3% Zr, 0.0008 to 0.006% B, up to 0.05% rare earth metals, up to 0.025% Mg plus optional Ca and the balance Ni including trace additions and impurities. The welding alloy offers a combination of high temperature strength, ductility, stability, toughness and essentially defect-free weldability and weldments as to render the alloy range uniquely suitable for joining boiler tubing to the header pipe in supercritical, ultra-supercritical and advanced ultra-supercritical boiler applications where essentially defect-free joining is critical.

### CROSS-REFERENCE TO RELATED APPLICATION

This application claims the benefit of U.S. Provisional Patent Application No. 61/075,980 filed Jun. 26, 2008, the contents of which are incorporated herein in its entirety.

### BACKGROUND OF THE INVENTION

1. Field of the Invention

The present invention relates to a welding alloy for joining tubing to a header pipe in boiler applications and, more particularly, to a nickel (Ni)-chromium (Cr)-cobalt (Co) base alloy possessing exceptional high temperature strength, steam and coal-ash corrosion resistance and essentially defect-free welding characteristics for joining tubing and tubing to header pipe for supercritical, ultra-supercritical and advanced ultra-supercritical service at 580° to 816° C. while retaining ductility, stability and toughness.

2. Description of Related Art

Metallurgists have been continually developing alloys to meet advancing requirements for both high strength at elevated temperatures and corrosion resistance under the severe environmental conditions operating in coal-fired boilers. This quest for increasing performance has taken on new urgency as utility designers and engineers seek to increase productivity and efficiency, lower operating costs, extend service lives and reduce plant emissions. There is a need presently in coal-fired supercritical, ultra-supercritical, and advanced ultra-supercritical boiler materials for advanced alloys to maintain progress. This new usage requires ever-increasing strength at increasingly higher temperatures, as operating conditions become more demanding and service lives are required to be trouble-free over the life of the boiler. Coal-fired boiler designers must develop new materials to meet their advanced requirements. Today's boilers, with efficiencies in the mid 40% range, typically operate up to 290 bar steam pressure and 580° C. steam temperature. Designers are setting their sights on 50% efficiency or better by raising the steam conditions as high as 325 bar/760° C. for advanced ultra-supercritical boiler operation. To meet such requirements in the boiler materials, the 100,000 hour stress rupture life must exceed 100 MPa at temperatures as high as 760° C.

In addition, raising steam temperature has made steam corrosion more troublesome placing a further requirement on any new alloy. This corrosion resistance requirement equates to less than 2 mm of metal loss in 200,000 hours for steam oxidation or coal-ash corrosion in the temperature range of 700° to 800° C. To construct a boiler in the field, a welding product is mandatory that produces essentially defect-free joints in both the boiler tubing and in joining the boiler tubing to the header pipe.

To meet the new strength and temperature requirements of future supercritical, ultra-supercritical and advanced ultra-supercritical boiler materials, designers must exclude the usual ferritic, solid solution austenitic and age-hardenable alloys heretofore employed for this service. These prior materials commonly lack one or more of the requirements of adequate strength, temperature capability, stability, coal-ash corrosion resistance or steam corrosion resistance. For example, a typical age-hardenable alloy must be alloyed with insufficient chromium for peak steam oxidation resistance in order to maximize the age-hardening potential of the alloy and to develop high strength at elevated temperatures. Adding chromium, not only degrades the strengthening mechanism, but also results in embrittling sigma, mu or alpha-chromium formation if added in excess. Since, 580° to 816° C. is a very active range for carbide precipitation and embrittling grain boundary film formation, alloy stability is compromised in many prior alloys in the interest of achieving high temperature strength and adequate coal-ash or steam oxidation resistance.

Accordingly, a need exists for a compositional alloy range for a welding product that extends service life in future coal-fired boiler applications notwithstanding the seemingly incongruous constraints imposed by the alloying elements economically available to the alloy developer. Past alloy developers commonly claimed broad ranges of their alloying elements which when combined in all purported proportions would have faced these counter influences on overall properties. Therefore, a further need exists for a narrow, critical range of a welding alloy composition that allows one to fabricate high temperature, high strength boiler materials that operate at 580° to 816° C., possessing coal-ash and steam oxidation corrosion resistance, phase stability, workability, and field weldability.

### SUMMARY OF THE INVENTION

The present invention is directed to a nickel (Ni), chromium (Cr), cobalt (Co), iron (Fe), molybdenum (Mo), manganese (Mn), aluminum (Al), titanium (Ti), niobium (Nb), silicon (Si) welding alloy, articles made therefrom for use in producing weldments and methods for producing these weldments. Briefly stated, the welding alloy contains in % by weight about: 23.5 to 25.5% Cr, 15 to 22% Co, up to 3% Fe, up to 1% Mo, up to 1% Mn, 1.1 to 2.0% Al, 0.8 to 1.8% Ti, 0.8 to 2.2% Nb, 0.05 to 0.28% Si, up to 0.3% tantalum (Ta), up to 0.3% tungsten (W), 0.005 to 0.08% carbon (C), 0.001 to 0.3% zirconium (Zr), 0.0008 to 0.006% boron (B), up to 0.05% rare earth metals, up to 0.025% magnesium (Mg) plus optional calcium (Ca) up to a combined Mg+Ca of 0.025% max, and the balance Ni including trace additions and impurities. The welding alloy of the present invention offers a combination of high temperature strength, ductility, stability, toughness and essentially defect-free weldability and weldments as to render the alloy range uniquely suitable for joining boiler tubing to the header pipe in supercritical, ultra-supercritical and advanced ultra-supercritical boiler applications where essentially defect-free joining is critical. The strength and stability is assured to steam temperatures as high as 760° C. when the Al/Ti weight % ratio is constrained to between 0.90 and 1.25. Further, the sum of the Al+Ti is controlled between 2.25 and 3.0 weight %. The limit for the sum of 0.5×Nb%+5×Si%+100×B% is less than 2.5% to assure essentially defect-free weldments in boiler tubing up to 10 mm and is less than 2.0% to assure essentially defect-free weldments in header pipe up to 80 mm thick. A better appreciation of the alloying difficulties can be presented by defining below the benefits and impediments associated with each element employed in this invention.

### DETAILED DESCRIPTION OF THE PRESENT INVENTION

The chemical compositions set forth throughout this specification are in weight percentages unless otherwise specified. In accordance with the present invention, the alloy broadly contains 23.5 to 25.5% Cr, 15 to 22% Co, up to 3% Fe, up to 1% Mo, up to 1% Mn, 1.1 to 2.0% Al, 0.8 to 1.8% Ti, 0.8 to 2.2% Nb, 0.05 to 0.28% Si, up to 0.3% Ta, up to 0.3% W, 0.005 to 0.08% C, 0.001 to 0.3% Zr, 0.0008 to 0.006% B, up to 0.05% rare earth metals, up to 0.025% Mg plus optional Ca and the balance Ni including trace additions and impurities. The strength and stability is assured to steam temperatures as high as 760° C. when the Al/Ti wt. % ratio is constrained to between 0.90 and 1.25. Further, the sum of the Al+Ti is held between 2.25 and 3.0 wt. %. The limit for the sum of 0.5×Nb%+5×Si%+100×B% is less than 2.5% to assure essentially defect-free weldments in boiler tubing up to 10 mm and is less than 2.0% to assure essentially defect-free weldments in header pipe up to 80 mm thick.

The above combination of elements possesses all the critical attributes required of the welding product used to join the components of supercritical, ultra-supercritical and advanced ultra-supercritical boilers. Coal-ash and steam oxidation resistance can be achieved by alloying with a narrow range of Cr (23.5-25.5%) without destroying phase stability resulting from embrittling phases by concurrently limiting certain other elements to very narrow ranges (e.g. less than 1% Mo, less than 0.08% C, less than 3.0% Fe and the total Ta plus W content to less than 0.6%). Less than 23.5% Cr results in inadequate coal-ash and steam oxidation resistance and greater than 25.5% Cr produces embrittling phases even with the alloy restrictions defined above. Too often, striving for maximum corrosion resistance results in alloys lacking the required high temperature strength. This has been solved in the alloy of the present invention by balancing the weight percent of precipitation hardening elements to a narrow range between about 14 and 20% within the Ni—Cr—Co matrix. Excessive amounts of the hardener elements not only reduce phase stability, lower ductility and toughness but also render pipe manufacturability extremely difficult if not impossible. The selection of each elemental alloying range can be rationalized in terms of the function each element is expected to perform within the compositional range of the alloy of the present invention. This rationale is defined below.

Chromium (Cr) is an essential element in the alloy range of the present invention because it assures development of a protective scale that confers the high temperature coal-ash and steam oxidation resistance vital for the intended application. In conjunction with the minor elements Zr (up to 0.3%), Mg (up to 0.025%) and Si (up to 0.28%), the protective nature of the scale is even more enhanced and made effective to higher temperatures. The function of these minor elements is to enhance scale adhesion, density and resistance to decomposition. The minimum level of Cr is chosen to assure adequate α-chromia formation at 580° and above. This minimum level of Cr was found to be about 23.5%. Higher Cr levels accelerate α-chromia formation but did not change the nature of the scale. The maximum Cr level for this alloy range was established to assure alloy phase stability and workability. This maximum level of Cr was found to be about 25.5%.

Cobalt (Co) is an essential matrix-forming element because it contributes to hot hardness and strength retention at the upper regions of the intended service temperature (580° to 816° C.) and contributes in a significant way to the high temperature corrosion resistance of the alloy range. However, because of cost, it is preferred to maintain the level of the Co content to 15.0 to 22.0%.

Aluminum (Al) is an essential element in the alloy range of this application because it not only contributes to deoxidation but because it reacts with Ni in conjunction with Ti and Nb to form the high temperature phase, gamma prime (Ni₃Al, Ti, Nb). The Al content is restricted to the range of 1.1 to 2.0%. The strength and stability is assured at 760° C. when the Al/Ti ratio is constrained to between 0.90 and 1.25. Further the sum of Al+Ti is constrained to between 2.25 and 3.0 thus assuring a gamma prime content of 14 to 20% by volume at service temperature. Larger amounts than 2.0% Al in conjunction with the other hardener elements markedly reduces ductility, stability and toughness and reduces workability of the alloy range. Internal oxidation can increase with higher amounts of Al.

Titanium (Ti) in the alloy range 1.0 to 1.8% is an essential strengthening element as stated above. Strength and stability is assured at 760° C. when the Al/Ti ratio is constrained to between 0.90 and 1.25. Further, the sum of Al+Ti is constrained to between 2.25 and 3.0. Ti also serves to act as grain size stabilizer in conjunction with Nb by forming a small amount of primary carbide of the (Ti, Nb)C type. The amount of carbide is limited to less than 1.0% by weight in order to preserve hot and cold workability of the alloy. Ti in amounts in excess of 1.8% can be prone to internal oxidation leading to reduced matrix ductility and can lead to formation of undesirable eta phase formation.

Niobium (Nb) in the alloy range 0.8 to 2.2% is also an essential strengthening and grain size control element. The Nb content must allow for at least 14% by volume gamma phase formation at 760° C. when Al and Ti are present. Nb along with Ti can react with C to form primary carbides which act as grain size stabilizers during hot working. An excessive amount of Nb can reduce the protective nature of protective scale and hence is to be avoided. It is a critical discovery that defect-free welded joints can only be achieved when the Nb and Si are critically controlled within limits. Nb and Si are inversely related in this regard. Higher Nb levels require lower Si levels and vice-versa. In general, the following formula defines the desired limits for Nb in relation to that of the Si and B content. The limit for the sum of 0.5×Nb%+5×Si%+100×B% is less than 2.5% to assure essentially defect-free weldments in INCONEL alloy 740 tubing up to 10 mm and is less than 2.0% to assure essentially defect-free weldments in INCONEL alloy 740 header pipe up to 80 mm thick.

Tantalum (Ta) and tungsten (W) also form primary carbides which can function similarly to that of Nb and Ti. However, their negative effect on α-chromia stability limits their presence of each to less than 0.3%.

Molybdenum (Mo) can contribute to solid solution strengthening of the matrix but must be considered an element to be restricted to less than 1.0% due to its apparent deleterious effect on coal-ash and steam oxidation resistance and TCP phase formation when added to a greater extent to the alloys of the present invention.

Manganese (Mn), while an effective desulfurizer during melting, is overall a detrimental element in that it reduces protective scale integrity. Consequently, Mn is maintained below 1.0%. Mn, above this level, degrades the α-chromia by diffusing into the scale and forming the spinel, MnCr₂O₄. This oxide is significantly less protective of the matrix than is α-chromia.

Silicon (Si) is an important element in the present alloy and contained in the range of 0.05 to 0.28%. Si forms an enhancing silica (SiO₂) layer beneath the α-chromia scale to further improve corrosion resistance. This is achieved by the blocking action that the silica layer contributes to inhibiting ingress of the corrosive gases of the boiler or the steam molecules in the header and the egress of cations of the alloy. Excessive amounts of Si can contribute to loss of ductility, toughness and workability. Si also widens the liquidus to solidus range of the compositional range of the alloy of the present invention and contributes in a significant way to the formation of grain boundary liquation in the weld and the heat affected zone of the base metal during welding. Therefore, its content must be critically limited to 0.28% max. for optimum results. Si acts in conjunction with Nb and B in this regard as defined hereinabove.

Iron (Fe) additions to the alloys of the present invention lower the high temperature corrosion resistance by reducing the integrity of the α-chromia by forming the spinel, FeCr₂O₄. Consequently, it is preferred that the level of Fe be maintained at 3.0% max. Excess Fe can also contribute to formation of undesirable TCP phases such as sigma phase.

Zirconium (Zr) in amounts between 0.001 to 0.3% and boron (B) in amounts between 0.0008 to 0.006% are effective in contributing to high temperature strength and stress rupture ductility. Larger amounts of these elements lead to grain boundary liquation and markedly reduced hot workability. Zr in the above compositional range also aids scale adhesion under thermally cyclic conditions. B in amounts between 0.0008 and 0.006% is effective in contributing to high temperature strength and stress rupture ductility. Larger amounts lead to grain boundary liquation and markedly reduced hot workability. Base plates of alloys J and K in Table III below demonstrate this point showing that B in alloy J (0.009%) that is outside the limits of the present invention is subject to gross fissuring (counts as high as 21 micro-fissures vs. 1 or 2 for alloy K where B is 0.004%). In addition, alloy J failed a 2T bend whereas alloy K did not. Alloys J and K were manual pulsed gas tungsten arc welded (p-GTAW) with filler metal L in Table III. Boron, because it widens the liquidus to solidus range of the compositional range of the alloy of the invention, contributes in a significant way to the formation of grain boundary liquation in the weld and the heat affected zone of the base metal during welding, hence the B content must be critically limited to 0.006% maximum for optimum results. B acts in conjunction with Nb and Si in this regard as discussed above.

Magnesium (Mg) and optionally calcium (Ca) in total amount up to 0.025% are both an effective desulfurizer of the alloy and a contributor to scale adhesion. Excessive amounts of these elements reduce hot workability and lower product yield. Trace amounts of rare earth metals, such as lanthanum (La), yttrium (Y) or Mischmetal may be present in the alloys of the invention as impurities or deliberate additions up to 0.05% to promote hot workability and scale adhesion. However, their presence is not mandatory as is that of Mg and optionally Ca.

Carbon (C) should be maintained between 0.005 to 0.08% to aid grain size control in conjunction with Ti and Nb since the carbides of these elements are stable in the hot working range (1000° to 1175° C.) of the compositional range of this patent application. These carbides also contribute to strengthening the grain boundaries to enhance stress rupture properties.

Nickel (Ni) forms the critical matrix and must be present in an amount greater than 45% in order to assure phase stability, adequate high temperature strength, ductility, toughness and good workability and weldability.

Table I, below, provides presently preferred ranges of elements that make up the alloy of the invention.

TABLE I
Designation of the Compositional Ranges for the Broad, Intermediate
and Narrow Limits for Welding Alloy of the Present Invention

| | Broad | Intermediate | Narrow |
|---|---|---|---|
| Element | Weight % | Weight % | Weight % |
| Cr | 23.5-25.5 | 24.0-25.5 | 24.0-25.0 |
| Co | 15.0-22.0 | 18.0-21.5 | 19.5-21.0 |
| Al | 1.1-2.0 | 1.1-1.8 | 1.2-1.5 |
| Ti | 0.8-1.8 | 1.0-1.6 | 1.1-1.5 |
| Nb | 0.8-2.2 | 0.9-2.1 | 0.9-2.0 |
| Mo | 0-1.0 | 0.3-0.8 | 0.5-0.8 |
| Mn | 0-1.0 | 0.1-0.8 | 0.2-0.5 |
| Si | 0.05-0.28 | 0.08-0.25 | 0.1-0.25 |
| Fe | 0-3.0 | 0.5-2.0 | 0.5-1.5 |
| Ta | 0-0.3 | 0-0.25 | 0.0005-0.2 |
| W | 0-0.3 | 0-0.25 | 0.001-0.2 |
| C | 0.005-0.08 | 0.01-0.06 | 0.02-0.05 |
| Zr | 0.001-0.3 | 0.001-0.25 | 0.001-0.2 |
| B | 0.0008-0.006 | 0.0008-0.005 | 0.0008-0.004 |
| Rare Earth | 0-0.05 | 0-0.04 | 0.0.03 |
| Mg | 0-0.025 | 0-0.022 | 0.005-0.02 |
| Mg + Ca | 0-0.025 | 0.001-0.025 | 0.005-0.02 |
| Ni | Balance | Balance | Balance |
| Al/Ti | 0.90-1.25 | 0.09-1.2 | 0.95-1.15 |
| Al + Ti | 2.25-3.0 | 2.25-2.95 | 2.3-2.9 |
| Equation 1* | <2.5 | <2.2 | <2.0 |

*Equation 1 is 0.5 × Nb % + 5 × Si % + 100 × B %

### Examples

Examples are set forth below. Examples of compositions within the alloy range of this patent range are presented in Table II and current commercial and experimental alloys outside the compositional limits of this patent application as defined by the equation “0.5×Nb%+5×Si%+100×B%” are listed in Table III.

TABLE II
Compositions of the Alloys in Accordance with the Present Invention

| Heat | Ni | Cr | Co | Al | Ti | Nb | Mo | Si | Fe | Mn | Zr | B | C | Mg + Ca | W | Ta | Al/Ti | Al + Ti | Eq. |
|---|---|---|---|---|---|---|---|---|---|---|---|---|---|---|---|---|---|---|---|
| A | 50.8 | 24.1 | 19.8 | 1.26 | 1.31 | 0.93 | 0.58 | 0.19 | 0.55 | 0.4 | .003 | .001 | .031 | .001 | .002 | .001 | 0.96 | 2.57 | 1.5 |
| B | 48.5 | 25.5 | 20.2 | 1.22 | 1.11 | 2.06 | 0.08 | 0.13 | 0.75 | 0.3 | .003 | .001 | .041 | .022 | .051 | .004 | 1.10 | 2.33 | 1.8 |
| C | 49.4 | 24.5 | 19.9 | 1.48 | 1.44 | 1.00 | 0.54 | 0.21 | 1.09 | 0.3 | 0012 | .001 | 0.05 | .008 | .006 | .001 | 1.02 | 2.92 | 1.7 |
| D | 48.9 | 24.3 | 20.8 | 1.44 | 1.42 | 1.05 | 0.54 | 0.22 | 1.05 | 0.3 | 0.14 | .001 | 0.03 | .006 | .002 | .001 | 1.01 | 2.86 | 1.7 |
| E | 49.1 | 24.5 | 20.0 | 1.46 | 143 | 1.31 | 0.54 | 0.24 | 1.04 | 0.3 | 0.10 | .003 | 0.04 | 0.13 | .003 | .001 | 1.02 | 2.89 | 2.2 |
| F | 49.1 | 24.6 | 20.1 | 1.28 | 1.11 | 1.56 | 0.54 | 0.22 | 1.01 | 0.3 | 0.13 | .001 | 0.04 | .007 | .002 | .001 | 1.15 | 2.39 | 2.0 |

Eq. = 0.5 × Nb % + 5 × Si % + 100 × B % = <2.5 for less than 10 mm tubing and <2.0 for 80 mm header pipe.

TABLE III
Compositions of Alloys Outside the Range of the Present Invention

| Heat | Ni | Cr | Co | Al | Ti | Nb | Mo | Si | Fe | Mn | Zr | B | C | Mg + Ca | W | Ta | Al/Ti | Al + Ti | Eq. |
|---|---|---|---|---|---|---|---|---|---|---|---|---|---|---|---|---|---|---|---|
| G* | 49.3 | 24.3 | 19.8 | 0.97 | 1.78 | 1.99 | 0.50 | 0.51 | 0.46 | 0.3 | .025 | .004 | 0.03 | .004 | .029 | .003 | 0.54 | 2.75 | 3.9 |
| H | 49.1 | 24.5 | 20.0 | 1.46 | 1.42 | 1.05 | 0.53 | 0.50 | 1.06 | 0.3 | .013 | .001 | 0.04 | .008 | .002 | .001 | 1.02 | 2.88 | 3.1 |
| I | 48.5 | 24.3 | 19.8 | 1.38 | 1.70 | 1.57 | 0.54 | 0.50 | 0.30 | 0.3 | .013 | .001 | 0.04 | .012 | .004 | .002 | 0.81 | 3.08 | 3.4 |
| J | 49.1 | 24.5 | 19.1 | 1.39 | 1.28 | 1.42 | 0.54 | 0.39 | 1.07 | 0.3 | .009 | .009 | 0.02 | .009 | .001 | .004 | 1.09 | 2.67 | 3.6 |
| K | 49.0 | 24.5 | 20.0 | 1.36 | 1.28 | 1.43 | 0.55 | 0.38 | 1.07 | 0.3 | .007 | .004 | 0.03 | .006 | .001 | .004 | 1.06 | 2.64 | 3.0 |
| L* | 49.7 | 24.1 | 20.0 | 0.63 | 2.10 | — | 5.80 | 0.5 m | .7 m | .6 m | — | .005 | 0.06 | .001 | .018 | .002 | 0.3 | 2.73 | — |

Eq. = 0.5 × Nb % + 5 × Si % + 100 × B % = <2.5 for less than 10 mm tubing and <2.0 for 80 mm header pipe.
*G is a commercial heat of INCONEL alloy 740
*L is a commercial filler metal of NIMONIC alloy 263, m = maximum

### Alloy Preparation and Mechanical Testing

Alloys C through F in Table II and H through K in Table III were vacuum induction melted as 25 kg ingots. The ingots were homogenized at 1204° C. for 16 hours and subsequently hot worked to 15 mm bar at 1177° C. with reheats as required to maintain the bar temperature at least at 1050° C. The final anneal was for a time of 1 hour at 1150° C. and water quenched. Standard tensile and stress rupture specimens were machined from both annealed and annealed plus aged bar (aged at 800° C. for 4 hours and air cooled). Alloys A and B in Table II were vacuum melted as 135 kg ingots and vacuum arc remelted followed by the hot working and heat treating as described above. Alloy G in Table III is a commercial heat of INCONEL alloy 740 and alloy L is a commercial heat of NIMONIC alloy 263. Annealed and aged room temperature tensile strength plus high temperature tensile properties are presented in Table IV for alloy C and in Table V for alloy B.

TABLE IV
Tensile Properties of Alloy C As-Annealed (1150° C./1
Hour/Water Quenched) and As-Annealed Plus Aged
(800° C./4 Hours/Air Cooled)

| | | | | |
|---|---|---|---|---|
| | Yield | Ultimate Tensile | | Reduction of |
| Temperature | Strength | Strength | Elongation | Area |
| (° C.) | (MPa) | (MPa) | (%) | (%) |

As- Annealed (1150° C./1 Hour/Water Quenched)

| | | | | |
|---|---|---|---|---|
| 74 | 314 | 796 | 57.5 | 67.5 |

As-Annealed Plus Aged (800° C./4 Hours/Air Cooled)

| | | | | |
|---|---|---|---|---|
| 74 | 721 | 1169 | 31.4 | 49.4 |
| 538 | 616 | 980 | 31.3 | 39.0 |
| 593 | 607 | 992 | 31.4 | 32.8 |
| 649 | 621 | 1023 | 38.4 | 39.8 |
| 704 | 648 | 914 | 37.9 | 43.7 |
| 760 | 608 | 766 | 32.5 | 43.9 |
| 800 | 556 | 652 | 34.8 | 46.2 |
| 816 | 514 | 608 | 37.7 | 47.8 |
| 871 | 304 | 365 | 55.2 | 67.8 |

TABLE V
Room Temperature Tensile Properties of Alloy B As-Annealed
(1150° C./1 Hour/Water Quenched) and As-Annealed plus
Aged (800° C./4 Hours/Air Cooled)

| | | Yield | Ultimate Tensile | | Reduction |
|---|---|---|---|---|---|
| | Heat | Strength | Strength | Elongation | Of Area |
| Alloy | Treatment | (MPa) | (MPa) | (%) | (%) |
| Alloy B | Annealed | 530 | 1002 | 43.4 | 47.4 |
| Alloy B | Aged | 724 | 1104 | 27.1 | 32.5 |

Table VI contains room temperature (RT) and 750° C. tensile data for transverse GTAW welded joints of alloys C, E and F in the annealed (1150° C./1h/WQ, aged (800° C./4h/AC), welded and re-aged as below condition.

TABLE VI
RT and 750° C. Tensile Results for Alloys C, E and F Transverse
Welded Joints. Specimens Were Annealed at 1150° C./1 Hour/Water
Quenched Plus Aged at 800° C./4 Hours/Air Cooled, Welded by
GTAW using Alloy A and Re-aged as Before.

| | | | Ultimate | | |
|---|---|---|---|---|---|
| | | Yield | Tensile | | Reduction |
| | Temperature | Strength | Strength | Elongation | Of Area |
| Alloy | ° C. | (MPa) | (MPa) | (%) | (%) |
| C | RT | 768 | 1114 | 25.0 | 28.5 |
| C | 750 | 610 | 765 | 10.5 | 22.5 |
| E | RT | 758 | 1091 | 21.5 | 32.5 |
| E | 750 | 629 | 773 | 11.0 | 16.0 |
| F | RT | 751 | 1099 | 23.5 | 23.5 |
| F | 750 | 603 | 756 | 12.5 | 11.5 |

Table VII contains RT and 750° C. tensile data for transverse GMAW welded joints of alloys B and C processed similarly to the specimens in Table VI.

TABLE VII
RT and 750° C. Tensile Results for Alloys B and C Transverse
Welded Joints. Specimens Were Annealed at 1150° C./1 Hour/Water
Quenched Plus Aged at 800° C./4 Hours/Air Cooled, Welded by
GMAW using Alloy A and Re-aged as Before.

| | | | Ultimate | | |
|---|---|---|---|---|---|
| | | Yield | Tensile | | Reduction |
| | Temperature | Strength | Strength | Elongation | Of Area |
| Alloy | ° C. | (MPa) | (MPa) | (%) | (%) |
| B | RT | 764 | 1023 | 17.6 | 34.0 |
| B | 750 | 647 | 808 | 6.1 | 6.6 |
| C | RT | 728 | 1027 | 24.5 | 34.5 |
| C | 750 | 617 | 774 | 12.4 | 22.0 |

Table VIII lists typical stress rupture test results for the alloy B and for welded joints of alloys B, C, E and F in Table IX.

TABLE VIII
Stress Rupture Test Results for Alloy B.

| | Temperature | Stress | Rupture Life | Elongation |
|---|---|---|---|---|
| Alloy | (° C.) | (MPa) | (Hours) | (%) |
| Alloy B | 750 | 379 | 58.4 | 4.5 |
| | 816 | 207 | 227 | 13.6 |
| | 900 | 100 | 71.2 | 53.8 |

All Specimens Were Annealed at 1150° C./1 Hour/Water Quenched Plus Aged at 800° C./4 Hours/Air Cooled.

TABLE IX
Stress Rupture Test Results for Alloys
B, C, E and F Transverse Welded Joints.

| | | | | |
|---|---|---|---|---|
| | Temperature | Stress | Rupture Life | Elongation |
| Alloy | (° C.) | (MPa) | (Hours) | (%) |

GTAW

| | | | | |
|---|---|---|---|---|
| C | 750 | 379 | 32.8 | 3.0 |
| E | 750 | 379 | 55.7 | 2.0 |
| F | 750 | 379 | 53.4 | 3.5 |

p-GMAW

| | | | | |
|---|---|---|---|---|
| B | 750 | 379 | 17.9 | 1.8 |
| C | 750 | 379 | 39.3 | 1.6 |

Specimens Were Annealed at 1150° C./1 Hour/Water Quenched Plus Aged at 800° C./4 Hours/Air Cooled, Welded by both gas tungsten arc welding (GTAW) and pulsed gas metal arc welding (p-GMAW) using Alloy A and Re-aged as Before.

Establishing the Welding Characteristics of the Alloys of this Invention

The tubing and header pipe welded joints must meet pressure code requirements of ASME, Section IX. The ability to satisfactorily make the welded joints of this alloy range is demonstrated below. Manual pulsed gas metal arc welding (p-GMAW) and gas tungsten arc welding (GTAW) were used to demonstrate essentially defect-free weldability. The welding parameters for both welding techniques are presented in Table X below.

TABLE X
Welding Parameters for the Alloys of the Present Invention

| | Manual Pulsed-Gas | Manual Gas |
|---|---|---|
| Parameter | Metal Arc Weld | Tungsten Arc Weld |
| Amperage | 130 ± 5 | 180 ± 5 |
| Voltage | 27.0 ± 1 | 15.0 ± .75 |
| Shielding Gas | 75/25 Argon/Helium | 75/25 Argon/Helium |
| | @35cfh | @30cfh |
| Electrode | | 2% Thoriated Tungsten, |
| | | ⅛″ diameter |
| Wire Speed | 250 IPM w/.045 Wire | |
| Travel Speed | ~10.0 IPM | ~8.0 IPM |

1.6 cm sections of alloys B and C were manual p-GMAW using alloy A from Table II and the welding parameters of Table X. Prior to welding, the alloys were annealed (1150° C. for 1 hour and water quenched) plus aged (800° C. for 4 hours and air cooled) and then re-aged as above after welding. Similarly, alloys C, E and F were GTAW using alloy A from Table II and the welding parameters of Table X. The welded joints were metallographically examined using up to five views. The base metals of these joints were deemed essentially defect-free and meeting the qualifications of ASME, Section IX. In that p-GMAW is a high heat input, rapid deposition welding technique, these results are deemed extremely significant and similar to those experienced using hot wire tungsten inert gas welding parameters.

Although the present invention has been described in conjunction with preferred embodiments, it is to be understood that modifications and variations may be resorted to without departing from the spirit and scope of the invention, as those skilled in the art will readily understand. Such modifications and variations are considered to be within the purview and scope of the invention and appended claims.

The invention claimed is:

1. A welding alloy possessing essentially defect-free weldability suitable for use in ultra-supercritical boiler application, comprising in % by weight: 23.5 to 25.5% Cr, 15 to 22% Co, up to 3% Fe, up to 1% Mo, up to 1% Mn, 1.1 to 2.0% Al, 0.8 to 1.8% Ti, 0.8 to 2.2% Nb, 0.05 to 0.28% Si, up to 0.3% Ta, up to 0.3% W, 0.005 to 0.08% C, 0.001 to 0.3% Zr, 0.0008 to 0.006% B, up to 0.05% rare earth metals, up to 0.025% Mg, balance Ni plus trace impurities.

2. An article for use in producing weldments between boiler tubing and a header pipe suitable for use outside a combustion section of a coal-fired ultra-supercritical boiler made from the alloy of claim 1.

3. The alloy of claim 1, further comprising Ca in an amount such that a combined amount of Mg and Ca is 0 to 0.025% in weight percent.

4. The alloy of claim 1, wherein an Al/Ti ratio is constrained to between 0.90 and 1.25 to assure strength and stability at 760° C. and wherein a sum of Al+Ti is constrained to between 2.25 and 3.0%.

5. The alloy of claim 1, wherein a limit for a sum of 0.5×Nb%+5×Si%+100×B% is less than 2.5% to assure essentially defect-free weldments in boiler tubing up to 10 mm.

6. The alloy of claim 1, wherein a limit for a sum of 0.5×Nb%+5×Si%+100×B% is less than 2.0% to assure essentially defect-free weldments in header pipe up to 80 mm thick.

7. A method of making a high temperature, high strength Ni—Co—Cr alloy suitable for use in ultra-supercritical boiler applications comprising the steps of:
(a) providing an alloy in ingot form comprising in weight %: 23.5 to 25.5% Cr, 15 to 22% Co, up to 3% Fe, up to 1% Mo, up to 1% Mn, 1.1 to 2.0% Al, 0.8 to 1.8% Ti, 0.8 to 2.2% Nb, 0.05 to 0.28% Si, up to 0.3% Ta, up to 0.3% W, 0.005 to 0.08% C, 0.001 to 0.3% Zr, 0.0008 to 0.006% B, up to 0.05% rare earth metals, up to 0.025% Mg, balance Ni plus trace impurities;
(b) homogenizing the ingot at about 1204° C. for about 16 hours to produce a homogenized ingot;
(c) hot working the homogenized ingot to a bar shape at about 1177° C. with reheats as required to maintain the temperature at least at 1050° C.;
(d) annealing the bar for a time of 1 hour per inch of material thickness at about 1150° C. followed by water quenching; and
(e) aging at 800° C. for four hours and air cooling.

8. The method of claim 7, including in step (a): vacuum induction melting and vacuum or electroslag arc remelting the alloy prior to step (b).

9. The method of claim 7, wherein the alloy further comprises Ca in an amount such that the amount of Mg and Ca is 0.001% to 0.025% in weight percent.

10. An article for use in producing weldments between boiler tubing and a header pipe suitable for use outside a combustion section of a coal-fired ultra-supercritical boiler made according to the method of claim 7.
